(19) United States
(12) Patent Application Publication
(10) Pub. No.: US 2007/0260813 A1
(43) Pub. Date: Nov. 8, 2007

(54) Apparatus for controlling access to non-volatile memory

(76) Inventor: Chih-Jung Lin, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,413

(22) Filed: Mar. 20, 2007

(30) Foreign Application Priority Data
Jan. 23, 2006 (TW) 095201456

(51) Int. Cl. G06F 12/00; G06F 13/28

(52) U.S. Cl. 711/103

(57) ABSTRACT

An apparatus for controlling data access to non-volatile memory is provided, including a micro-controller and at least a memory controller. The micro-controller includes a data/address bus and a plurality of control pins. The micro-controller controls the data access. The memory controller includes a flash memory controller, a FIFO buffer and an error correction unit. The flash memory controller is connected to the control pins and the data/address bus of the micro-controller. The flash memory controller is also connected to the non-volatile memory through a non-volatile memory bus so that the flash memory controller is the data access and control interface between the micro-controller and the non-volatile memory. The FIFO buffer is connected to the micro-controller and the error correction unit to provide the buffering of data access. The error correction unit is connected to the flash memory controller and the non-volatile memory to provide error correction of data access to achieve the object of direct control of data access to the non-volatile memory.

### BACKGROUND OF THE INVENTION

1. Field of the Invention

The present invention generally relates to an apparatus for controlling access to non-volatile memory and, more particularly, to an apparatus for controlling data access to non-volatile memory, such as flash memory, with a single memory controller.

2. The Related Arts

Non-volatile memory is widely used in many types of digital equipment, such as the flash memory in flash memory sticks and MP3 players. FIG. 1 of the attached drawings shows a conventional data access control for a non-volatile memory, including a micro-controller A1, a first bus controller A2, and a second bus controller A3. The micro-controller A1 uses a first bus B1 to connect the first bus controller A2. The first bus B1 is an address and data bus. The first bus controller A2 uses a second bus B2 to connect the second bus controller A3. The second bus B2 can be a USB or IDE bus. The second bus controller A3 uses a third bus B3 to connect a non-volatile memory A4. The third bus B3 is a Control, Address, and Data bus. The micro-controller A1, the first bus controller A2, the second bus controller A3, the first bus B1, the second bus B2, and the third bus B3 form the data access control mechanism of non-volatile memory A4. The micro-controller A1 controls the data access to the non-volatile memory A4 through the connection and data exchange among the first bus controller A2, the second bus controller A3, the first bus B1, the second bus B2, and the third bus B3.

The data access control mechanism of the non-volatile memory A4 in FIG. 1 must go through a plurality of layers of connection and interface conversion, including the micro-controller A1, the first bus controller A2, the second bus controller A3, the first bus B1, the second bus B2, and the third bus B3. The lack of direct connection between the micro-controller A1 and the non-volatile memory A4 will cause severe delay and long waiting time in data access control. In addition, using a multi-bus connection mechanism including the micro-controller A1, the first bus controller A2, the second bus controller A3, the first bus B1, the second bus B2 and the third bus B3, will complicate the circuit design and routing, which will lead to the increase of manufacturing cost. Because the buffering and the error correction of data access is not complete in one activity, the waiting time of the data access is increased.

### SUMMARY OF THE INVENTION

Thus, a primary object of the present invention is to provide an apparatus for controlling data access to non-volatile memory, including a micro-controller and at least a memory controller. The micro-controller is connected to the memory controller through control pins, data and address buses. The memory controller is connected to a non-volatile memory through a non-volatile memory bus. The access to the non-volatile memory is controlled through the micro-controller and the memory controller so that the delay in data transmission is reduced and the circuit is simplified to lower the manufacturing cost.

Another object of the present invention is to provide an apparatus for controlling data access to non-volatile memory, where the memory controller includes a flash memory controller, a first-in-first-out (FIFO) buffer and an error correction unit. The flash memory controller provides the access interface between the micro-controller and the non-volatile memory so that the micro-controller can access the non-volatile through the simplest mechanism. The FIFO buffer and the error correction unit provide the buffering and the error correction of data access control so that the buffering and the error correction can be executed at the same time to accelerate the data access.

To achieve the aforementioned objects, the present invention provides an apparatus for controlling data access to non-volatile memory, comprising a micro-controller and at least a memory controller. The micro-controller comprises a data/address bus and a plurality of control pins. The micro-controller controls the data access. The memory controller comprises a flash memory controller, a FIFO buffer and an error correction unit. The flash memory controller is connected to the control pins and the data/address bus of the micro-controller. The flash memory controller is also connected to the non-volatile memory through a non-volatile memory bus so that the flash memory controller is the data access and control interface between the micro-controller and the non-volatile memory. The FIFO buffer is connected to the micro-controller and the error correction unit to provide the buffering of data access. The error correction unit is connected to the flash memory controller and the non-volatile memory to provide error correction of data access to achieve the object of direct control of data access to the non-volatile memory.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a block diagram of a conventional access control module of non-volatile memory;

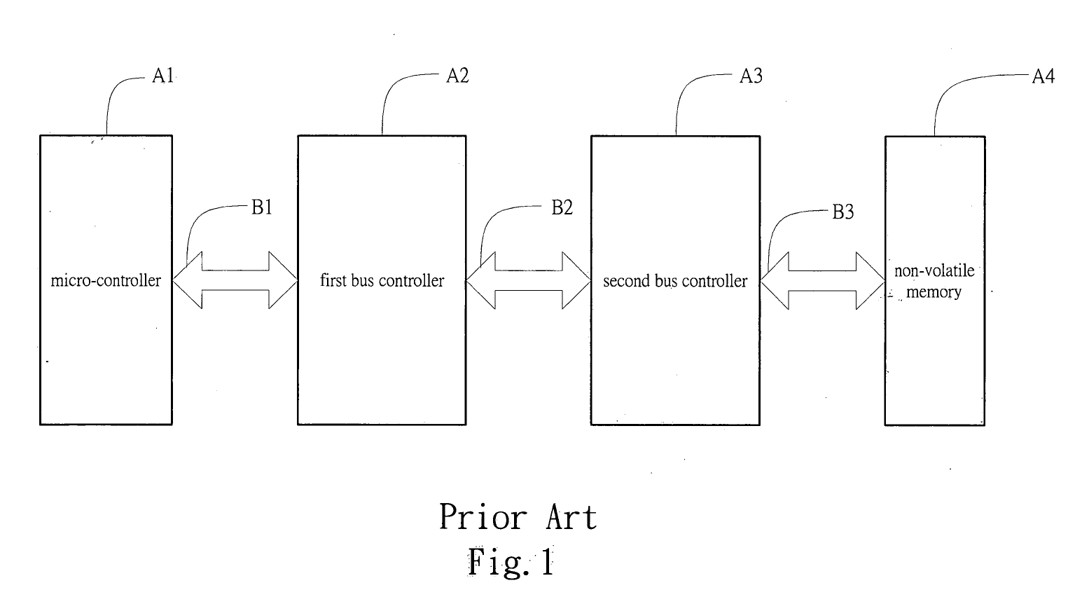

FIG. 2 s is a system block diagram of the present invention; and

FIG. 3 is the detailed circuit of the memory controller of the present invention.

### DETAILED DESCRIPTION OF THE PREFERRED EMBODIMENTS

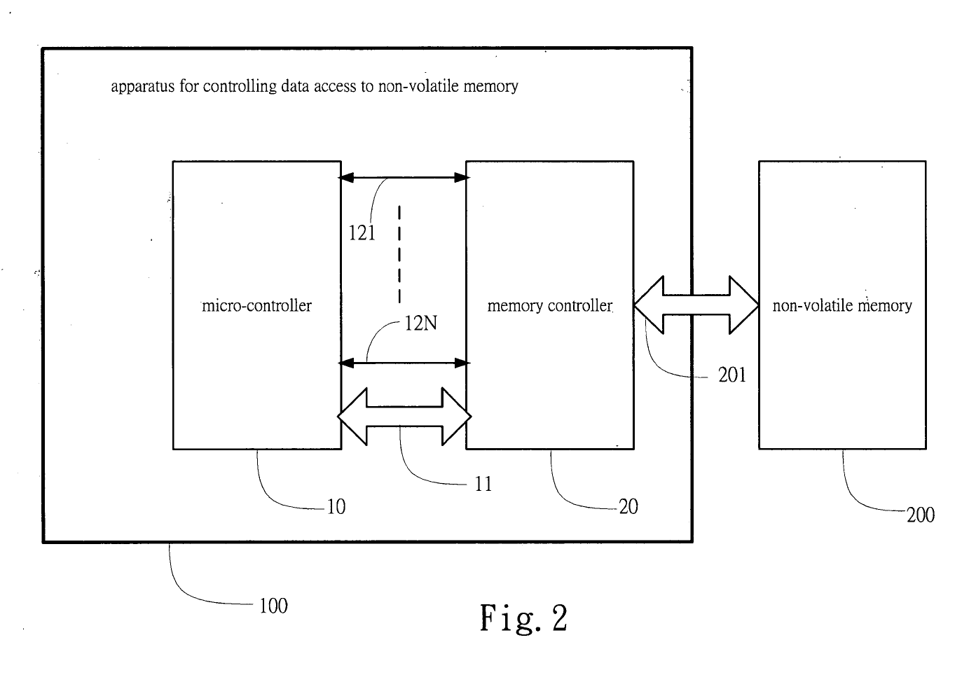

With reference to the drawings and in particular to FIG. 2, which shows an apparatus, generally designated with reference numeral 100, for controlling data access to non-volatile memory, the apparatus 100 comprises a micro-controller 10 and at least a memory controller 20. The micro-controller 10 comprises a data/address bus 11 and a plurality of control pins 121-12N. The micro-controller 10 controls the data access. The micro-controller 10 is not limited to any specific type, and can be an 8-bit, 16-bit, 32-bit, or 64-bit single chip micro-controller.

The memory controller 20 provides the data access control interface. The memory controller 20 is connected to the data/address bus 11 and control pins 121-12N of the micro-controller 10. The memory controller 20 is also connected to a non-volatile memory 200 through a non-volatile memory bus 201 so that the memory controller 20 provides the data access control interface between the micro-controller 10 and the non-volatile memory 200. Therefore, the micro-controller 10 can directly control the data access to the non-volatile memory 200 through the memory controller 20 without layers of buses and interfaces, as in the conventional design. The non-volatile memory 200 is not limited to any specific type. The embodiment of the present invention uses flash memory for description, but any equivalent memory devices are also within the scope of the present invention.

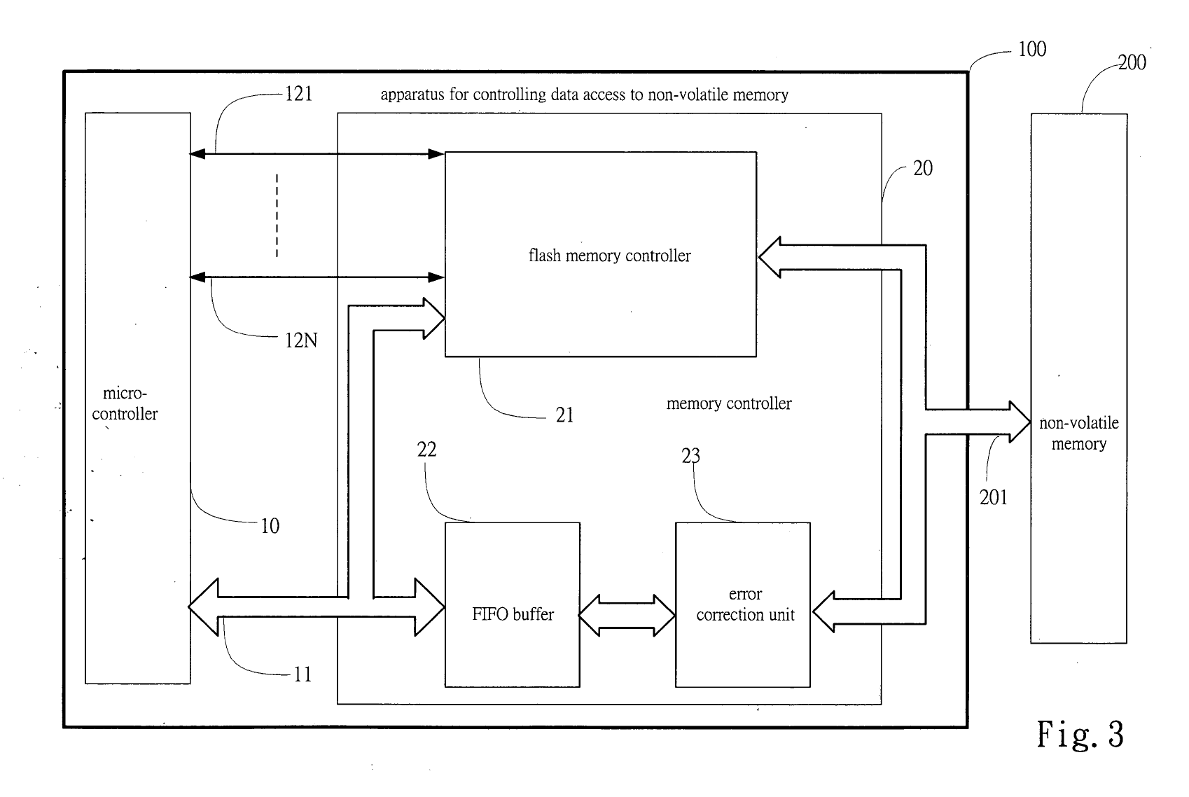

The memory controller 20 is not limited any specific type. FIG. 3 shows a preferred embodiment of the present invention, but any equivalent circuits or controllers are also within the scope of the present invention. The memory controller 20 comprises a flash memory controller 21, a FIFO buffer 22 and an error correction unit 23. The flash memory controller 21 is connected to the data/address bus 11 and the control pins 121-12N of the micro-controller 10. The flash memory controller 21 is also connected to the non-volatile memory 200 through the non-volatile memory bus 201 so that the flash memory controller 21 provides the data access interface between the micro-controller 10 and the non-volatile memory 200.

The FIFO buffer 22 is connected to the flash memory controller 21 and the data/address bus 11 to provide the data buffering for the micro-controller 10 in controlling the non-volatile memory 200. The error correction unit 23 is connected to the FIFO buffer 22, the flash memory controller 21 and the non-volatile memory bus 201 to provide the data error correction for the micro-controller 10 in controlling the non-volatile memory 200. Through the design of the memory controller 20, the data access control, buffering and error correction of the non-volatile memory 200 can be executed at the same time so that the speed and efficiency of data access control to non-volatile memory is improved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An apparatus for controlling data access to non-volatile memory, comprising:
a micro-controller, comprising a data/address bus and a plurality of control pins; and
a memory controller, connected to the control pins and the data/address bus of the micro-controller, and connecting a non-volatile memory through a non-volatile memory bus for providing data access control interface between the micro-controller and the non-volatile memory.

2. The apparatus as claimed in claim 1, wherein the memory controller further comprising:
a flash memory controller, connected to the control pins and the data/address bus of the micro-controller and non-volatile memory bus for providing data access control interface between the micro-controller and the non-volatile memory;
a first-in-first-out (FIFO) buffer, connected to the flash memory controller and the data/address bus of the micro-controller for providing buffering and temporary storage of data during data access control of the non-volatile memory; and
an error correction unit, connected to the FIFO buffer, the flash memory controller and the non-volatile memory bus for providing data error correction of non-volatile memory data access.

3. The apparatus as claimed in claim 1, wherein the non-volatile memory comprises flash memory.
